(19) United States
(12) Patent Application Publication
(10) Pub. No.: US 2022/0365723 A1
(43) Pub. Date: Nov. 17, 2022

(54) STORAGE SYSTEM AND STORAGE CONTROL METHOD

(71) Applicant: FUJITSU LIMITED, Kawasaki-shi (JP)

(72) Inventors: ERIKA HAYASHI, Yokohama (JP); HIROKI OHTSUJI, Yokohama (JP)

(73) Assignee: FUJITSU LIMITED, Kawasaki-shi (JP)

(21) Appl. No.: 17/592,550

(22) Filed: Feb. 4, 2022

(30) Foreign Application Priority Data
May 12, 2021 (JP) 2021-080916

(51) Int. Cl. G06F 3/06

(52) U.S. Cl. CPC G06F 3/0659; G06F 3/0635; G06F 3/0613; G06F 3/0617; G06F 3/0683

(57) ABSTRACT

A system including: a computer, a first controller, and a second controller, wherein the computer that transmits a write request for a data piece, write a first replica corresponding to the data piece, and in response to a notification indicating completion of the write request, deletes the first replica from the computer, the first controller that monitors a load on the second controller, in response to the write request, writes the data piece to the first controller and transmits the notification, in response that an indicator indicating the load is less than a predetermined threshold value after the transmission of the notification, transmits to the second controller a write request that requests to write a second replica corresponding to the data piece, and in response that the writing of the second replica completes, transmits the notification indicating completion of the write request to the computer.

### CROSS-REFERENCE TO RELATED APPLICATION

This application is based upon and claims the benefit of priority of the prior Japanese Patent Application No. 2021-80916, filed on May 12, 2021, the entire contents of which are incorporated herein by reference.

### FIELD

The embodiments disclosed herein relate to a storage system and a storage control method.

### BACKGROUND

In a storage system, one data piece is stored in a plurality of storage devices to achieve redundancy of the data piece. For example, there is a method in which, in response to receipt of a request to write a data piece, a storage control apparatus writes the data piece in a storage device and requests another storage control apparatus to write a replica of the data piece to another storage device.

In terms of such data redundancy, a redundant server system as will be described below has been proposed. In this server system, a server monitors a usage rate of a central processing unit (CPU) of the server, and, if the CPU usage rate is higher than a predetermined threshold value, the server inhibits new replication to be performed.

In terms of control over data writing, a data storage device as will be described below has been proposed. The data storage device holds an inputted data piece to be written in a non-volatile buffer, transfers a copy of the data piece to be written to a non-volatile main memory, and keeps holding the data piece to be written in the non-volatile buffer until success of the transfer to the non-volatile main memory is verified.

Examples of the related art include as follows: Japanese Laid-open Patent Publication No. 2007-286952; and Japanese Laid-open Patent Publication No. 2014-154168.

### SUMMARY

According to an aspect of the embodiments, there is provided a storage system including: an information processing apparatus, a first storage control apparatus, and a second storage control apparatus, wherein the information processing apparatus includes: a first storage device; and a first processing circuit configured to transmit a data write request for a data piece to be written to the first storage control apparatus, write a first replica corresponding to the data piece to be written to the first storage device, and in response to receipt of a replica write completion notification corresponding to the data write request, delete the first replica from the first storage device, the first storage control apparatus includes: a second storage device; and a second processing circuit configured to monitor a processing load on the second storage control apparatus, in response to receipt of the data write request from the information processing apparatus, write the data piece to be written to the second storage device and transmit a write completion notification to the information processing apparatus, in response that an indicator indicating the processing load is less than or equal to a predetermined threshold value after the transmission of the write completion notification, transmit to the second storage control apparatus a replica write request that requests to write a second replica corresponding to the data piece to be written, and in response that the writing of the second replica completes, transmit the replica write completion notification corresponding to the data write request to the information processing apparatus, and the second storage control apparatus has a third storage device; and a third processing circuit configured to in response to receipt of the replica write request, write the second replica to the third storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example and a processing example of a storage system according to a first embodiment;

FIG. 2 illustrates a configuration example of a storage system according to a second embodiment;

FIG. 3 illustrates a hardware configuration example of a server;

FIG. 4 illustrates a configuration example of processing functions of a client and servers;

FIG. 5 illustrates a data configuration example of a write management table;

FIG. 6 is a sequence diagram illustrating a first processing example of data writing;

FIG. 7 is a sequence diagram illustrating a second processing example of data writing;

FIG. 8 is an example of a flowchart illustrating a procedure of write requesting processing by a client;

FIG. 9 is an example of a flowchart illustrating a procedure of replica deleting processing by the client;

FIG. 10 is an example of a flowchart illustrating a procedure of dynamic random-access memory (DRAM) monitoring processing by a server;

FIG. 11 is an example of a flowchart illustrating a procedure of write request receiving processing by the server;

FIG. 12 is an example of a flowchart illustrating a procedure of replica writing processing by the server;

FIG. 13 is an example of a flowchart illustrating a procedure of write requesting processing by a client according to a third embodiment;

FIG. 14 illustrates a data configuration example of a write management table according to the third embodiment;

FIG. 15 illustrates other management data to be used in the third embodiment;

FIG. 16 is an example of a flowchart illustrating a procedure of table reset processing by a server;

FIG. 17 is an example of a flowchart illustrating a procedure of write request receiving processing by the server according to the third embodiment;

FIG. 18 is an example (Part 1) of a flowchart illustrating a procedure of replica writing processing by the server according to the third embodiment;

FIG. 19 is an example (Part 2) of a flowchart illustrating a procedure of the replica writing processing by the server according to the third embodiment;

FIG. 20 is an example (Part 3) of a flowchart illustrating a procedure of the replica writing processing by the server according to the third embodiment;

FIG. 21 illustrates a data configuration example of a replica management table held by a client according to a fourth embodiment;

FIG. 22 is a sequence diagram illustrating an example of data writing processing in a storage system according to the fourth embodiment;

FIG. 23 is an example of a flowchart illustrating a procedure of write requesting processing by the client according to the fourth embodiment;

FIG. 24 is an example of a flowchart illustrating a procedure of replica deleting processing by a client according to the fourth embodiment; and

FIG. 25 is an example of a flowchart illustrating a procedure of write request receiving processing by a server according to the fourth embodiment.

### DESCRIPTION OF EMBODIMENTS

As a method for dual-redundancy of a data piece, there is a method in which, in response to a request to write a data piece, writing of the data piece and writing of a replica thereof are performed synchronously. In this method, in response to receipt of a request to write a data piece, a storage control apparatus writes the data piece in a storage device, requests another storage control apparatus to write a replica of the data piece to another storage device, and, after the data writing and the replica writing complete, responds to the apparatus requesting the writing.

However, there is a possibility that, according to this method, the replica writing processing disadvantageously increases the processing load on the other storage control apparatus. For that, there is a possibility that the performance of processing other than the replica writing, which is being executed in the other storage control apparatus, is reduced.

According to one aspect, it is an object of embodiments to provide a storage system and a storage control method that may reduce the processing load on a storage control apparatus which writes a replica of a data piece.

Embodiments of the present disclosure will be described below with reference to the drawings.

### First Embodiment

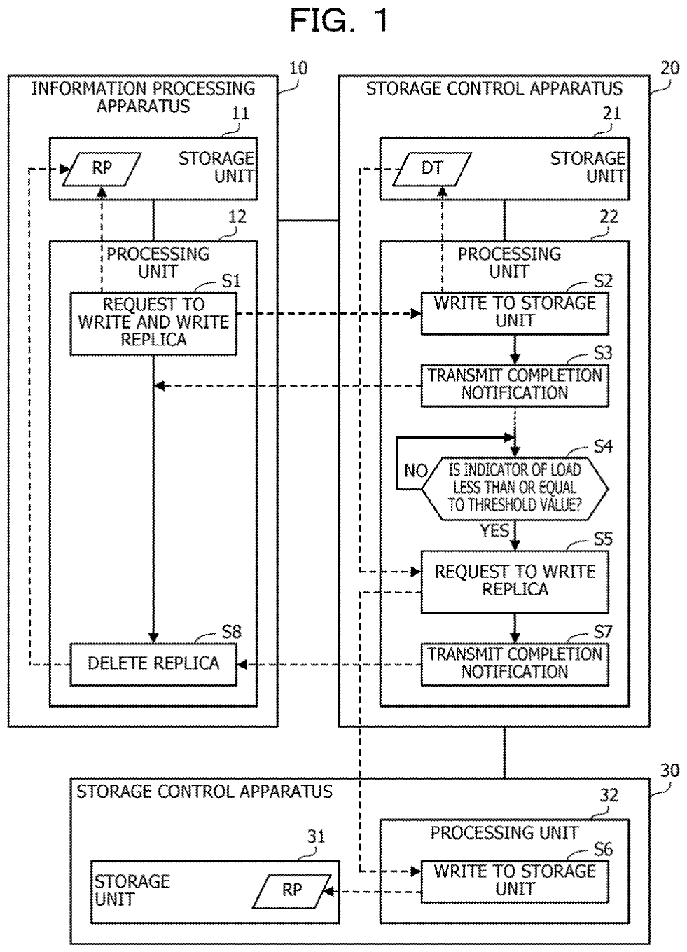

FIG. 1 illustrates a configuration example and a processing example of a storage system according to a first embodiment. A storage system illustrated in FIG. 1 includes an information processing apparatus 10 and storage control apparatuses 20, 30. FIG. 1 has solid arrows indicating a flow of processing and broken arrows indicating a flow of various kinds of data.

The information processing apparatus 10 requests one of the storage control apparatuses 20, 30 to write a data piece. The information processing apparatus 10 includes a storage unit 11 and a processing unit 12. The storage unit 11 is, for example, a non-volatile storage device. The processing unit 12 is, for example, a processor.

The storage control apparatus 20 includes a storage unit 21 and a processing unit 22. The storage control apparatus 30 includes a storage unit 31 and a processing unit 32. The storage units 21 and 31 are, for example, non-volatile storage devices. The processing units 22 and 32 are, for example, processors.

In response to a request from an information processing apparatus (the information processing apparatus 10 or another information processing apparatus, not illustrated), the storage control apparatus 20 writes a data piece to the storage unit 21. Similarly, in response to a request from the information processing apparatus, the storage control apparatus 30 writes a data piece to the storage unit 31. One storage control apparatus of the storage control apparatuses 20, 30 writes a replica of the data piece written to the storage unit of the one storage control apparatus to the storage unit of the other storage control apparatus. Thus, the data piece requested to write is redundantly stored in the plurality of storage devices.

The example in FIG. 1 assumes that the information processing apparatus 10 requests the storage control apparatus 20 to write a data piece. In this case, the storage control apparatus 20 writes the data piece requested to be written from the information processing apparatus 10 to the storage unit 21, and the storage control apparatus 30 writes a replica of the data piece to the storage unit 31.

As a write control method involving writing a replica, a method may be considered in which, for example, when the storage control apparatus 20 receives a request to write a data piece from the information processing apparatus 10, a replica thereof is immediately written to the storage unit 31 of the storage control apparatus 30. In this case, when the writing of the data piece to be written to the storage unit 21 and the writing of the replica to the storage unit 31 complete, the storage control apparatus 20 returns a response to the write request to the information processing apparatus 10.

However, there is a possibility that, according to this method, the writing processing on the storage unit 21 disadvantageously increases the processing load on the storage control apparatus 20. For example, there is a possibility that the increase in processing load disadvantageously reduces the performance of the writing processing requested to the storage control apparatus 20 itself by the information processing apparatus. Accordingly, in this embodiment, the processing load on the storage control apparatus 30 to which a replica is written is reduced by data writing processing executed by a procedure as will be described below.

The processing unit 22 in the storage control apparatus 20 monitors a processing load on the storage control apparatus 30. For example, the processing unit 22 periodically obtains an indicator indicating a processing load on the storage control apparatus 30 from the storage control apparatus 30. As the processing load on the storage control apparatus 30, for example, a processing load on a memory sharing the same bus with the storage unit 31 is monitored. As the processing load on the memory, for example, the number of accesses to the memory in a predetermined period of time or a memory usage rate is monitored.

It is assumed that the processing unit 12 in the information processing apparatus 10 has transmitted a request to write a data piece DT to the storage control apparatus 20. Then, the processing unit 12 writes a replica RP of the data piece DT to the storage unit 11 (step S1). The processing unit 22 in the storage control apparatus 20 writes the data piece DT to the storage unit 21 (step S2). The processing unit 12 transmits to the information processing apparatus 10 a completion notification indicating that the writing has completed (step S3).

Thereafter, the monitoring for the processing load on the storage control apparatus 30 by the processing unit 22 is continued (step S4). If the indicator indicating the processing load is less than or equal to a predetermined threshold value, the processing unit 22 requests the storage control apparatus 30 to write the replica RP of the data piece DT written to the storage unit 21 in step S2 (step S5). In response to receipt of the request to write the replica RP, the processing unit 32 in the storage control apparatus 30 writes the replica RP to the storage unit 31 (step S6).

When the writing of the replica RP to the storage unit 31 completes, the processing unit 22 in the storage control apparatus 20 transmits to the information processing apparatus 10 a completion notification indicating that the writing of the replica RP has completed (step S7). In response to receipt of the completion notification, the processing unit 12 in the information processing apparatus 10 deletes the replica RP written to the storage unit 11 in step S1 (step S8).

Through the processing above, writing of a replica to the storage unit 31 in the storage control apparatus 30 is executed asynchronously with the data write request from the information processing apparatus 10. Thus, at the time when the storage control apparatus 20 responds to the write request, the data piece is not redundant. Accordingly, the information processing apparatus 10 transmits a write request to write a data piece and writes a replica of the data piece to the storage unit 11 so that redundancy of the data is achieved and the security is acquired.

The storage control apparatus 20 monitors a processing load on the storage control apparatus 30, and, at a time when it is determined that the processing load is low, requests the storage control apparatus 30 to write a replica. Thus, the peak value of the processing load on the storage control apparatus 30 may be suppressed. For that, for example, reduction of the performance of processing being executed in the storage control apparatus 20 and excluding the replica writing may be suppressed.

Therefore, according to the first embodiment, redundancy of data is achieved and security of the data is acquired, and, at the same time, the processing load on the storage control apparatus 30 to which a replica of the data is to be stored may be reduced.

### Second Embodiment

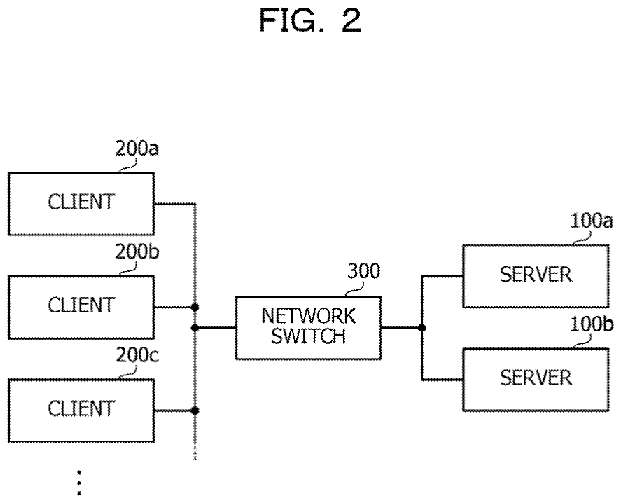

FIG. 2 illustrates a configuration example of a storage system according to a second embodiment. The storage system illustrated in FIG. 2 includes servers 100a, 100b, and clients 200a, 200b, 200c, . . . . The servers 100a, 100b and the clients 200a, 200b, 200c, . . . are coupled to each other over a network. In the example in FIG. 2, the servers 100a, 100b and the clients 200a, 200b, 200c, . . . are coupled to each other via a network switch 300.

Each of the servers 100a, 100b internally contains a persistent memory (PMEM), and a data piece is written to the PMEM in response to a request from at least one of the clients 200a, 200b, 200c, . . . . The PMEM is a non-volatile memory to/from which writing/reading is performed faster than a solid-state drive (SSD) although the cost per capacity is lower than that of a dynamic random-access memory (DRAM). As the PMEM, for example, a magnetoresistive random-access memory (MRAM), a resistive random-access memory (ReRAM), a phase change memory (PCM) or the like is used.

Each of the servers 100a, 100b writes a data piece requested to write to the PMEM in the server and writes a replica of the data piece to the PMEM in the other server. Thus, redundancy of the data piece is achieved. Hereinafter, the other server that holds a replica of the data stored in one server may be referred to as “replica server” in some cases.

The client 200a, 200b, 200c, . . . requests to write a data piece to one of the servers 100a, 100b. The server to which a data piece is to be written may be determined in advance for each client or may be determined based on the data piece. Each of the clients 200a, 200b, 200c, . . . internally contains a PMEM. A replica of a data piece requested to write is temporarily stored in the PMEM, as will be described below.

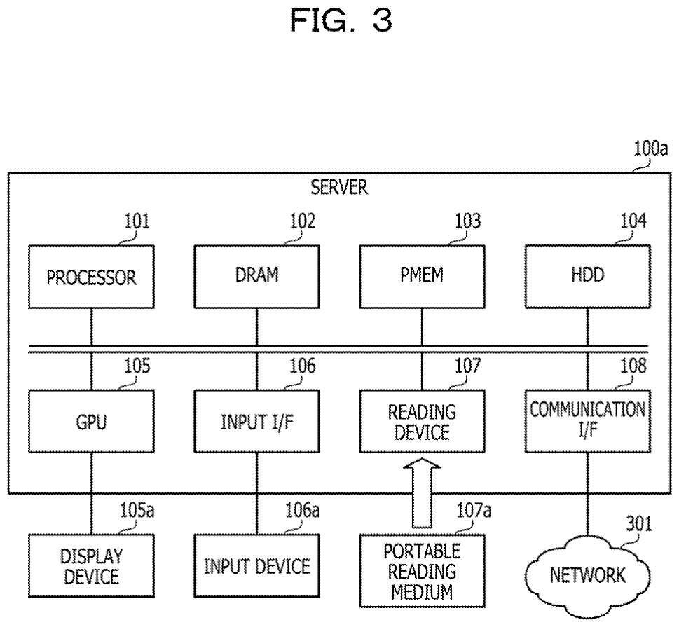

FIG. 3 illustrates a hardware configuration example of a server. FIG. 3 is a diagram illustrating a hardware configuration example of the server 100a as an example.

The server 100a is implemented, for example, as a computer as illustrated in FIG. 3. The server 100a illustrated in FIG. 3 includes a processor 101, a DRAM 102, a PMEM 103, a hard disk drive (HDD) 104, a graphics processing unit (GPU) 105, an input interface (I/F) 106, a reading device 107, and a communication interface (I/F) 108.

The processor 101 centrally controls the entire server 100a. The processor 101 is, for example, a CPU, a microprocessor unit (MPU), a digital signal processor (DSP), an application-specific integrated circuit (ASIC), or a programmable logic device (PLD). The processor 101 may also be a combination of two or more elements among the CPU, the MPU, the DSP, the ASIC, and the PLD.

The DRAM 102 is used as a main storage device of the server 100a. The DRAM 102 temporarily stores at least a part of an operating system (OS) program and an application program to be executed by the processor 101. The DRAM 102 stores various types of data to be used for processing by the processor 101.

The PMEM 103 stores various types of data to be used for processing by the processor 101. The PMEM 103 is used as a destination to which a data piece requested to write by a client is to be written or a destination to which a replica of the data piece is to be written.

The HDD 104 is used as an auxiliary storage device of the server 100a. The HDD 104 stores an OS program, an application program, and various types of data. As the auxiliary storage device, an SSD, for example, may be used.

A display device 105a is coupled to the GPU 105. The GPU 105 causes the display device 105a to display an image in accordance with an instruction from the processor 101. The display device may be a liquid crystal display, an organic electroluminescence (EL) display, or the like.

An input device 106a is coupled to the input interface 106. The input interface 106 transmits a signal output from the input device 106a to the processor 101. Examples of the input device 106a include a keyboard, a pointing device and the like. The pointing device may be a mouse, a touch panel, a tablet, a touch pad, a track ball, or the like.

A portable recording medium 107a is removably attached to the reading device 107. The reading device 107 reads data recorded in the portable recording medium 107a and transmits the data to the processor 101. The portable recording medium 107a may be an optical disk, a semiconductor memory, or the like.

The communication interface 108 transmits and receives data to and from other apparatuses such as the server 100b and the clients 200a, 200b, 200c, . . . and the like over the network 301.

With the hardware configuration as described above, processing functions of the server 100a may be implemented. The server 100b and the clients 200a, 200b, 200c, . . . may also be implemented by the hardware configuration as illustrated in FIG. 3.

When a replica of a data piece written to one server is to be written to a replica server, there is a problem that the replica writing processing increases the processing load on the replica server. For example, in the servers 100a, 100b of this embodiment, the DRAM and the PMEM share a memory bus to/from the processors, and a conflict over the memory bus may possibly occur between the DRAM and the PMEM. For example, when writing is performed on the PMEM in a state that the DRAM is under high access load, the performance of the processing for accessing the DRAM is reduced.

Accordingly, in this embodiment, a server requesting to write a replica monitors the access load on the DRAM in the replica server. The server requests the replica server to write a replica in a state that the access load on the DRAM is low. Thus, the peak value of the access load on the DRAM in the replica server is reduced, and the processing performance of each kind of application in the replica server is enhanced. For example, the response performance is enhanced when the replica server executes data writing/reading in response to a request from the client.

According to this embodiment, it is assumed that the number of accesses to the DRAM in a predetermined period of time is used as an indicator indicating an access load on the DRAM.

As a method for writing a replica to the replica server, there are a method which writes a replica synchronously with a request to write a data piece from the client and a method which writes the replica asynchronously. In order to write a replica when the access load on the DRAM in the replica server is low as described above, the replica writing is desirably performed asynchronously. However, in this case, at a time when the client requests to write a data piece and receives a response thereto, dual-redundancy of the data piece requested to write is not achieved, causing a problem that the security of the data is lowered.

Accordingly, in this embodiment, when the client requests to write a data piece to the server, the client also writes a replica of the data piece to the PMEM of the client. In response to receipt of a notification indicating completion of the replica writing from the server, the client deletes the replica held in the PMEM in the client. Thus, the redundancy of the data piece is achieved, and the security of the data piece is enhanced.

However, if a small space is available in the PMEM in the client, there is a possibility that the replica may not be held on the client. Accordingly, in this embodiment, when data writing is requested from the client to the server, an available space flag indicating whether the available space is small in the PMEM in the client or not is attached to the write request, which is then transmitted. If the available space flag indicates that the available space is small, the server having received the write request writes the data piece to the PMEM in the server and requests the replica server to write a replica of the data piece and returns a response to the client when the replica writing completes. Thus, dual redundancy of the data piece is securely achieved. This suppresses occurrence of a situation in which the client may not request data writing because the available space in the PMEM in the client is exhausted.

As an example, in the following description, a case will be described where the client 200a requests to write a data piece to the server 100a, and the server 100b operates as the replica server that holds a replica of the data piece.

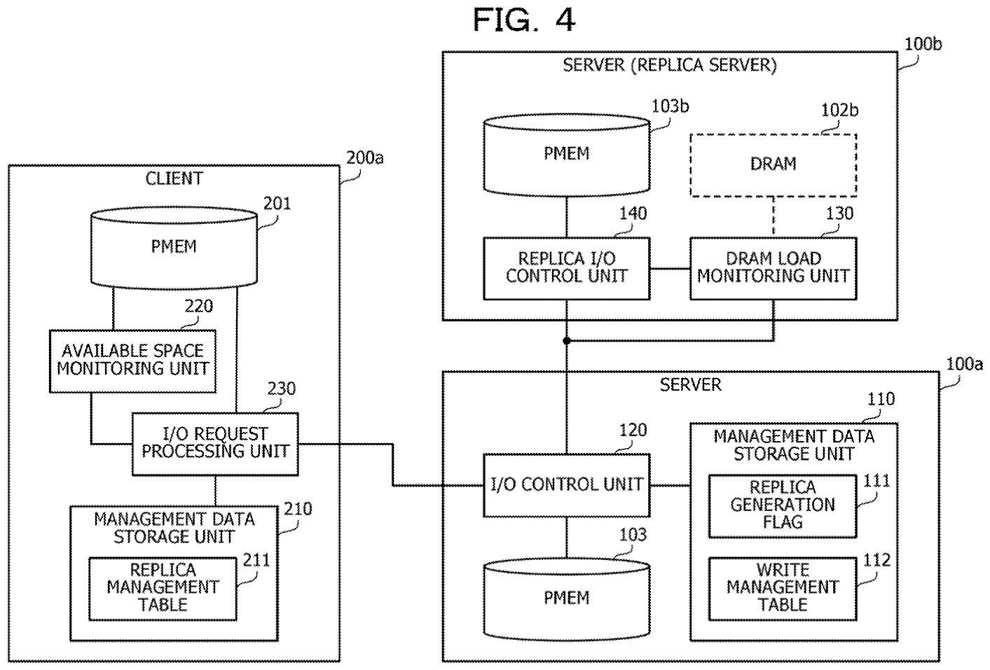

FIG. 4 illustrates a configuration example of processing functions of the client and the servers.

First of all, the client 200a includes a PMEM 201 as hardware. The client 200a further includes a management data storage unit 210, an available space monitoring unit 220, and an input/output (I/O) request processing unit 230.

The management data storage unit 210 is implemented by a storage area in a storage device, not illustrated, included in the client 200a, such as a DRAM, HDD or the like. In the management data storage unit 210, a replica management table 211 is stored as management data. A write destination address of each of original data pieces corresponding to replicas written to the PMEM 201 is registered with the replica management table 211. This write destination address is information for identifying a write destination of a data piece and is, for example, a logical address on a logical volume or directory information on a file system.

The processing of the available space monitoring unit 220 and the I/O request processing unit 230 is achieved by, for example, causing a processor, not illustrated, included in the client 200a to execute a predetermined program.

The available space monitoring unit 220 monitors an available space in the PMEM 201 and notifies the available space to the I/O request processing unit 230.

When requesting to write a data piece to the server 100a, the I/O request processing unit 230 attaches an available space flag indicating whether the available space in the PMEM 201 is small or not to the write request based on the notification from the available space monitoring unit 220 and transmits the write request. If the available space in the PMEM 201 is less than or equal to a predetermined threshold value, the available space flag is set to “1”. The I/O request processing unit 230 writes to the PMEM 201 a replica of the data piece requested to write and registers the address for the data piece with the replica management table 211.

Each of the clients 200b, 200c, . . . has similar processing functionality to that of the client 200a.

Next, the server 100a includes a PMEM 103 as hardware, as described above. The server 100a further includes a management data storage unit 110 and an I/O control unit 120 as functions for executing I/O control in accordance with a request from the client.

The management data storage unit 110 is implemented by a storage area in a storage device included in the server 100a, such as the DRAM 102, the HDD 104, or the like. In the management data storage unit 110, a replica generation flag 111 and a write management table 112 are stored.

The replica generation flag 111 is flag information indicating whether generation of a replica (writing of a replica to the replica server) is possible or not. If the indicator for the access load on the DRAM (the number of accesses to the DRAM in a predetermined period of time) in the replica server is less than or equal to a predetermined threshold value, the replica generation flag 111 is set to “1”.

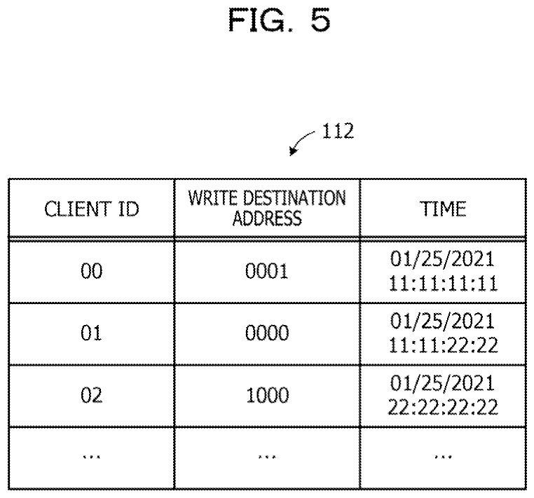

The information illustrated in FIG. 5, which will be described next, is registered with the write management table 112 for each client requesting to write a data piece.

FIG. 5 illustrates a data configuration example of the write management table. As illustrated in FIG. 5, a write destination address and a time are registered with the write management table 112 for each client ID identifying a client having requested to write a data piece. The write destination address is information for identifying a write destination of data and is, for example, a logical address on a logical volume or directory information on a file system. The time indicates a time when data writing to the write destination address has been requested. When data writing to the same write destination address is requested a plurality of number of times, the time when the last data write request has been issued is registered with the time field.

The description is continued below by using FIG. 4.

Processing by the I/O control unit 120 is implemented by, for example, causing the processor 101 included in the server 100a to execute a predetermined program.

In response to receipt of a data write request to write a data piece from the client 200a, the I/O control unit 120 writes the data to be written to the PMEM 103. If the available space flag attached to the write request is “0”, the I/O control unit 120 writes a replica of the data piece to be written to the PMEM 103 and transmits to the client 200a a completion notification for the write request. At that time, information regarding the data piece to be written is registered with the write management table 112. On the other hand, if the available space flag attached to the write request is “1”, the I/O control unit 120 requests the replica server (server 100b) to write a replica of the data piece to be written. When the writing of the data piece to be written to the PMEM 103 and the writing of the replica in the replica server complete, the I/O control unit 120 transmits to the client 200a a replica generation completion notification as well as the completion notification for the write request. In this case, information registration with the write management table 112 is not performed.

The I/O control unit 120 periodically obtains an indicator indicating a load on the DRAM in the replica server (the number of times of writing in a predetermined period of time) from the replica server and sets the replica generation flag 111 to “1” if the indicator is less than or equal to a predetermined threshold value. The I/O control unit 120 requests the replica server to write a replica of the data piece written to the PMEM 103 based on the write management table 112 during a period when the replica generation flag 111 is “1”.

Next, the server 100b includes a DRAM 102b and a PMEM 103b as hardware. The DRAM 102b is used as a main storage device in the server 100b, like the DRAM 102 in the server 100a. A data piece requested to write by a client is written and a replica of the data piece requested to write to the server 100a are stored in the PMEM 103b.

The server 100b includes a DRAM load monitoring unit 130 and a replica I/O control unit 140 as functions as the replica server. The processing of the DRAM load monitoring unit 130 and the replica I/O control unit 140 is achieved by, for example, causing a processor, not illustrated, included in the server 100b to execute a predetermined program.

The DRAM load monitoring unit 130 monitors a load on the DRAM 102b. For example, the DRAM load monitoring unit 130 measures the number of accesses to the DRAM 102b in a predetermined period of time as an indicator indicating a load and notifies the measurement result to the server 100a.

The replica I/O control unit 140 writes a replica to the PMEM 103b in response to the request from the server 100a.

The processing functionality of the server 100a illustrated in FIG. 4 is also included in the server 100b. The processing functionality (processing functionality as the replica server) of the server 100b illustrated in FIG. 4 is also included in the server 100a.

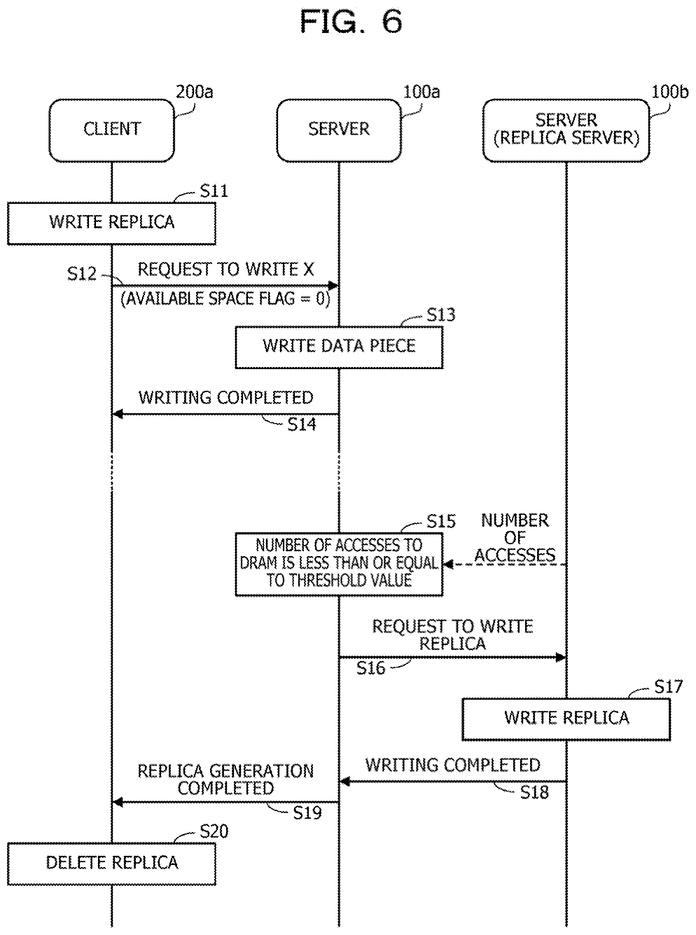

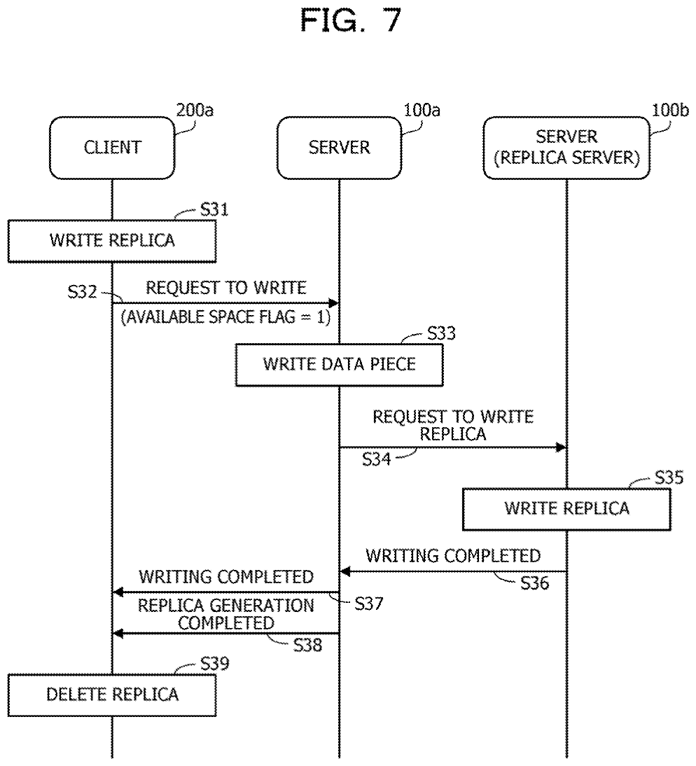

Next, with reference to FIGS. 6 and 7, an outline of writing processing in the storage system according to the second embodiment will be described.

FIG. 6 is a sequence diagram illustrating a first processing example of data writing.

The client 200a writes a replica of a data piece to be written to the PMEM 201 (step S11) and transmits a request to write the data piece to the server 100a (step S12). It is assumed here that the available space in the PMEM 201 of the client 200a is greater than or equal to a predetermined threshold value and that the available space flag attached to the write request is “0” indicating that the available space is sufficient.

In response to receipt of the write request, the server 100a writes the data piece requested to write to the PMEM 103 (step S13). If the server 100a recognizes that the available space flag attached to the write request is “0”, the server 100a transmits to the client 200a a write completion notification indicating that the data writing has completed (step S14).

The server 100a periodically obtains from the server 100b the number of accesses to the DRAM 102b in the server 100b (replica server) in a predetermined period of time (hereinafter, simply called “the number of accesses to the DRAM 102b”). Such periodical obtaining is continued even after the write completion notification is transmitted in step S14. When the number of accesses to the DRAM 102b is less than or equal to the predetermined threshold value (step S15), the server 100a transmits to the server 100b a replica write request to request to write a replica of the data piece written to the PMEM 103 in step S13 (step S16).

In response to receipt of the replica write request, the server 100b writes the replica to the PMEM 102b (step S17) and transmits to the server 100a a replica write completion notification indicating that the replica writing has completed (step S18). In response to receipt of the replica write completion notification, the server 100a transmits to the client 200a a replica generation completion notification indicating that the replica generation has completed (step S19). In response to receipt of the replica generation completion notification, the client 200a deletes the replica written to the PMEM 201 in step S11 from the PMEM 201 (step S20).

Through the processing above, the replica writing to the PMEM in the replica server is executed in a state that the access load on the DRAM in the replica server is low. Thus, the peak value of the access load on the DRAM in the replica server may be reduced, and the processing performance of each kind of application in the replica server may be enhanced. For example, the response performance may be enhanced when the replica server executes data writing/reading in response to a request from the client.

The replica writing to the replica server is executed at a time asynchronous to the request to write the original data piece. On the other hand, the client transmits the write request and holds a replica of the data piece in the PMEM within the client. This allows redundant storage of the data piece in the plurality of PMEMs even during a period of time until writing of the replica of the data piece is executed on the replica server. Therefore, the redundancy of the data piece is achieved, and the security of the data may be enhanced.

FIG. 7 is a sequence diagram illustrating a second processing example of data writing.

The client 200a writes a replica of a data piece to be written to the PMEM 201 (step S31) and transmits a request to write the data piece to the server 100a (step S32). Unlike the case in FIG. 6, it is assumed here that the available space in the PMEM 201 of the client 200a is less than the predetermined threshold value and that the available space flag attached to the write request is “1” indicating that the available space is small.

In response to receipt of the write request, the server 100a writes the data piece requested to write to the PMEM 103 (step S33). When the server 100a recognizes that the available space flag attached to the write request is “1”, the server 100a transmits to the server 100b a replica write request to request to write a replica of the data piece written to the PMEM 103 (step S34). This replica write request is executed regardless of the number of accesses to the DRAM 102b in the server 100b.

In response to receipt of the replica write request, the server 100b writes the replica to the PMEM 102b (step S35) and transmits to the server 100a a replica write completion notification indicating that the replica writing has completed (step S36). In response to receipt of the replica write completion notification, the server 100a transmits to the client 200a a write completion notification indicating that the data writing has completed (step S37). Also, the server 100a transmits to the client 200a a replica generation completion notification indicating that the replica generation has completed (step S38). The write completion notification and the replica generation completion notification may be notified to the client 200a by one data transmission operation.

In response to receipt of the write completion notification and the replica generation completion notification, the client 200a deletes the replica written to the PMEM 201 in step S31 from the PMEM 201 (step S39).

Through the processing described above, when the available space in the PMEM in the client is small, the replica writing to the replica server is executed while the corresponding data piece is written to the PMEM in the server. When these writing operations complete, the replica generation completion notification is transmitted to the client, and the replica held in the PMEM in the client is deleted. Thus, the replica written to the PMEM in the client is deleted in a shorter time than that in the case in FIG. 6 from the time when the client requests to write the data piece.

For example, when the processing as illustrated in FIG. 6 is executed even on the PMEM having a small available space in the client, the available space in the PMEM in the client is further reduced, and there is a possibility that the PMEM will be exhausted soon. When the PMEM in the client is exhausted, the client may not request to write a data piece by keeping redundancy of the data piece. The processing illustrated in FIG. 7 may reduce the possibility that such a situation occurs.

Next, processing by the client 200a and the server 100a is described by using flowcharts.

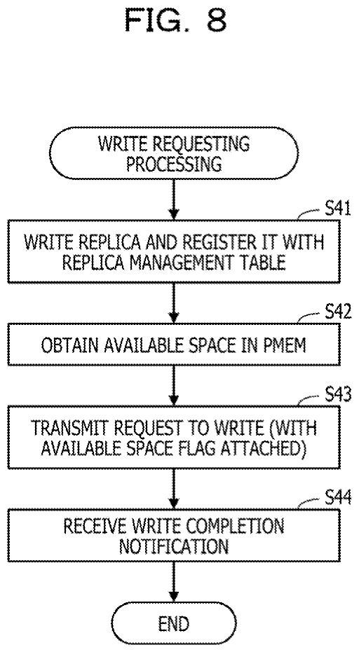

FIG. 8 is an example of a flowchart illustrating a procedure of write requesting processing by a client.

[Step S41] The I/O request processing unit 230 in the client 200a writes to the PMEM 201 a replica of a data piece requested to write and registers the write destination address for the data piece with the replica management table 211.

However, when the write destination address for the data piece requested to write has already been registered with the replica management table 211, the I/O request processing unit 230 does not update the replica management table 211. Instead, the I/O request processing unit 230 overwrites the data for the same write destination address, which has already been stored in the PMEM 201, with the data piece newly requested to write.

[Step S42] The I/O request processing unit 230 obtains the available space in the PMEM 201 from the available space monitoring unit 220.

[Step S43] The I/O request processing unit 230 determines the value of the available space flag by comparing the obtained available space with a predetermined threshold value. When the available space is less than or equal to the threshold value, the available space flag is determined to be “1”, and, when the available space is greater than the threshold value, the available space flag is determined to be “0”. The I/O request processing unit 230 attaches the available space flag having the determined value to the write request requesting to write the data piece and transmits the write request to the server 100a.

[Step S44] The I/O request processing unit 230 receives from the server 100a a write completion notification corresponding to the transmitted write request.

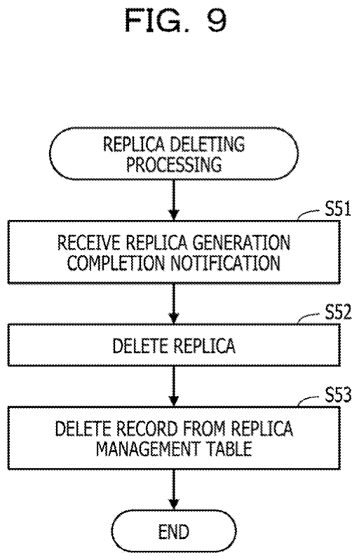

FIG. 9 is an example of a flowchart illustrating a procedure of replica deleting processing by the client.

[Step S51] The I/O request processing unit 230 receives a replica generation completion notification from the server 100a. A write destination address for the corresponding data piece to be written is attached to the replica generation completion notification.

[Step S52] The I/O request processing unit 230 extracts the write destination address attached to the replica generation completion notification from the replica management table 211 and deletes the replica corresponding to the write destination address from the PMEM 201.

[Step S53] The I/O request processing unit 230 deletes the write destination address identified in step S52 from the replica management table 211.

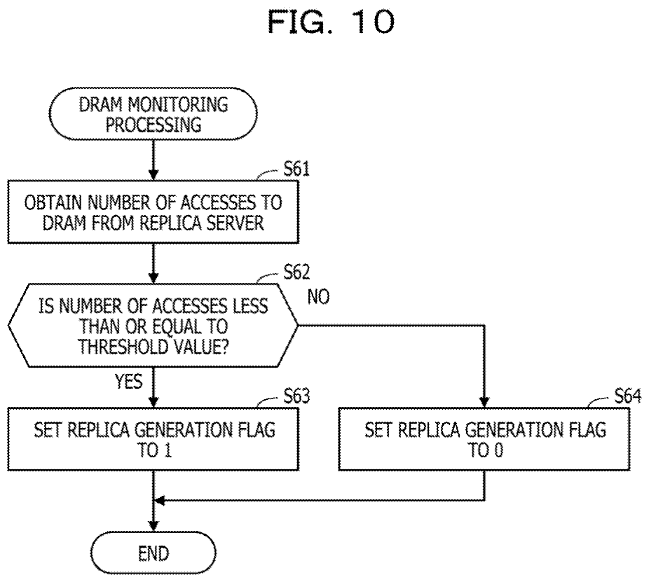

FIG. 10 is an example of a flowchart illustrating a procedure of DRAM monitoring processing by the server. The processing illustrated in FIG. 10 is repeatedly executed at predetermined time intervals.

[Step S61] The I/O control unit 120 in the server 100a obtains, from the server 100b, the number of accesses to the DRAM 102b in the server 100b (replica server).

[Step S62] The I/O control unit 120 determines whether the obtained number of accesses is less than or equal to a predetermined threshold value. If the number of accesses is less than or equal to the threshold value, the processing proceeds to step S63, and, if the number of accesses is greater than the threshold value, the processing proceeds to step S64.

[Step S63] The I/O control unit 120 sets (or updates) the replica generation flag 111 to “1”.

[Step S64] The I/O control unit 120 sets (or updates) the replica generation flag 111 to “0”.

Through the processing above, the replica generation flag 111 indicates “1” when the access load on the DRAM 102b in the replica server is small, which allows to request to write a replica.

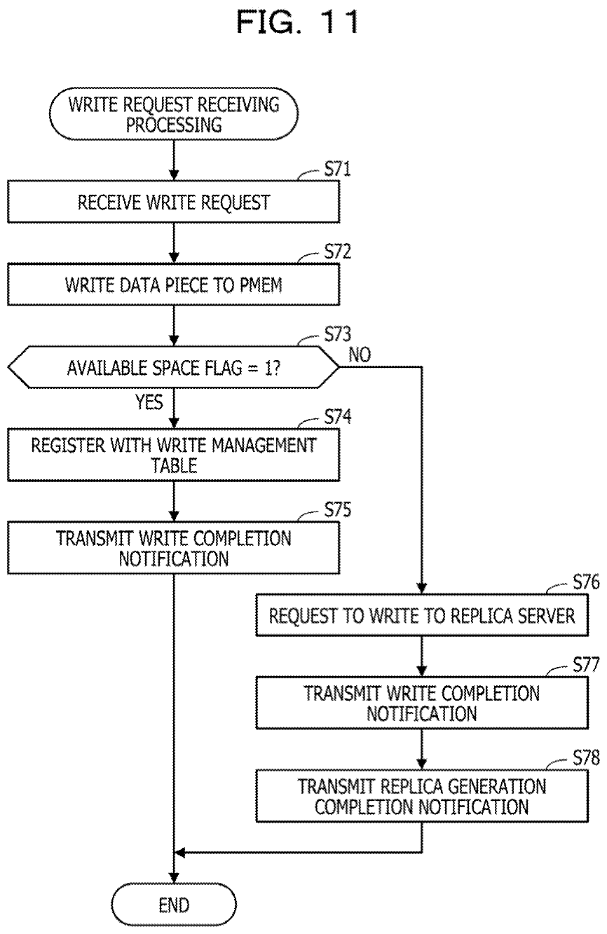

FIG. 11 is an example of a flowchart illustrating a procedure of write request receiving processing by the server.

[Step S71] The I/O control unit 120 in the server 100a receives a request to write a data piece from a client.

[Step S72] The I/O control unit 120 writes the data piece requested to write to the PMEM 103.

[Step S73] The I/O control unit 120 obtains the available space flag attached to the write request. When the available space flag is“1”, the processing proceeds to step S74, and, when the available space flag is “0”, the processing proceeds to step S76.

[Step S74] The I/O control unit 120 generates a new record in the write management table 112 and registers a client ID indicating the transmission source client of the write request, a write destination address of the data piece requested to write, and the current time with the record. However, when any record exists to which the same address is registered as the write destination address of the data piece requested to write, the I/O control unit 120 updates the time registered with the record with the current time, without generating a new record.

[Step S75] The I/O control unit 120 transmits a write completion notification corresponding to the write request to the transmission source client of the write request.

[Step S76] The I/O control unit 120 transmits to the server 100b (replica server) a replica write request that requests to write a replica of the data piece requested to write.

[Step S77] The I/O control unit 120 transmits a write completion notification corresponding to the write request to the transmission source client of the write request.

[Step S78] The I/O control unit 120 transmits to the transmission source client of the write request a replica generation completion notification indicating that the replica writing has completed. A write destination address for the corresponding data piece is attached to the replica generation completion notification. When the record including the write destination address exists in the write management table 112, the I/O control unit 120 deletes the record.

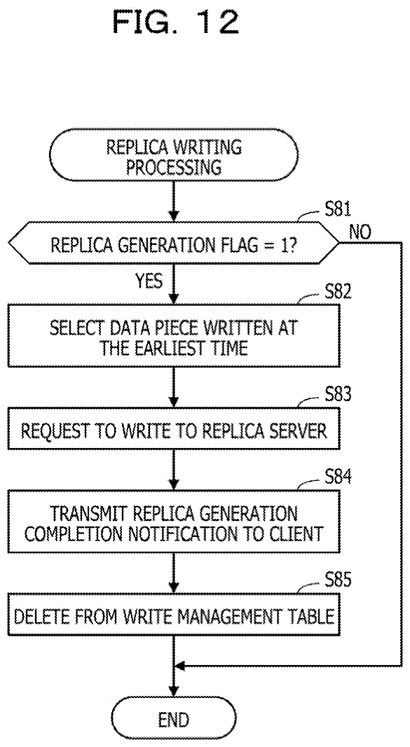

FIG. 12 is an example of a flowchart illustrating a procedure of replica writing processing by the server. The processing illustrated in FIG. 12 is repeatedly executed at predetermined time intervals.

[Step S81] The I/O control unit 120 in the server 100a determines whether the replica generation flag 111 is “1”. When the replica generation flag 111 is “1”, the processing proceeds to step S82, and, when the replica generation flag 111 is “0”, the processing in FIG. 12 ends.

[Step S82] The I/O control unit 120 selects a record having the earliest time among the records in the write management table 112. Thus, a data piece requested to write at the earliest time is selected among data pieces for which replica writing has not completed.

[Step S83] The I/O control unit 120 transmits to the server 100b (replica server) a replica write request that requests to write a replica of the data piece selected in step S82.

[Step S84] In response to receipt of a write completion notification for the replica write request, the I/O control unit 120 transmits to the transmission source client of the write request a replica generation completion notification indicating that the replica writing has completed. A write destination address for the corresponding data piece is attached to the replica generation completion notification.

[Step S85] The I/O control unit 120 deletes the record selected in step S82 from the write management table 112.

Through the processing in FIG. 12 above, data pieces are selected in order from the data piece requested to write at the oldest time among the data pieces for which the replica writing has not completed in a period of time when the load on the DRAM in the replica server is low, and a replica of the selected data piece is written to the replica server.

### Third Embodiment

A storage system according to the third embodiment is acquired by changing a part of the processing of the storage system according to the second embodiment. According to the third embodiment, for each client requesting to write data pieces and based on various conditions, priority levels are given to the data pieces for which replica writing has not been executed in the server, and a replica of the data piece selected based on its priority level is written to the replica server.

An available space in the PMEM in a client is used as one of the conditions for replica writing, and a data piece requested to write by the client having a small available space in the PMEM is selected by the highest priority, and a replica of the data piece is written to the replica server. For example, for a data piece requested to write by a client having an available space in the PMEM less than or equal to a predetermined threshold value, the replica writing is executed, regardless of the access load on the DRAM in the replica server.

Through the processing above, replicas of data pieces requested to write by a client having a smaller available space in the PMEM are written earlier in the replica server, and, with that, the replicas within the PMEM in the client are deleted earlier. This may suppress the possibility that the client may not request data writing because the available space of the PMEM in the client is exhausted.

As another condition for replica writing, the number of times of writing from the client in a predetermined period of time and an amount of data written from the client in a predetermined period of time are used. A data piece requested to write from a client having the number of times of writing, which is the former condition, greater than or equal to a predetermined threshold value is selected as a data piece at the second highest priority level, and writing of a replica for the data piece is executed. As the number of times of writing requested from one client in a predetermined period of time increases, more replicas are stored in the PMEM in the client, and the available space of the PMEM is reduced. A replica for a data piece requested to write by a client having a higher number of times of writing in a predetermined period of time is written to the replica server by priority so that the replica stored in the PMEM in the client may be deleted early and the available space in the PMEM may be increased.

However, since replicas corresponding to data pieces for the same write destination address are overwritten in the PMEM in the client, the available space in the PMEM is not increased. For that, as the number of times of writing, the number of requests to write to different write destination addresses in a predetermined period of time is measured. The number of requests may also be referred to as the number of data pieces requested to write to different write destinations.

The data piece requested to write from a client having a higher amount of data written from the client in a predetermined period of time is selected as a data piece at the third highest priority level, and writing of a replica for the data piece is executed. As the amount of data requested to write from one client in a predetermined period of time increases, the total amount of data of the replicas stored in the PMEM in the client increases, and the available space of the PMEM is reduced. A replica for a data piece requested to write by a client having a higher amount of data written in a predetermined period of time is written to the replica server by priority so that the replica stored in the PMEM in the client may be deleted early and the available space in the PMEM may be increased.

However, as described above, since replicas corresponding to data pieces for the same write destination address are overwritten in the PMEM in the client, the available space in the PMEM is not increased. For that, as the amount of written data, the amount of data requested to write to different write destination addresses in a predetermined period of time is measured.

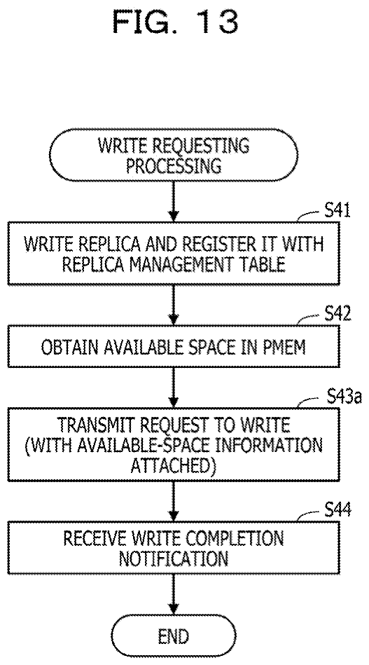

FIG. 13 is an example of a flowchart illustrating a procedure of write requesting processing by a client according to the third embodiment. In FIG. 13, processing steps including the same operations as those in FIG. 8 are denoted with the same numbers, and the repetitive description thereof is omitted herein. In the processing in FIG. 13, the following step S43a is executed instead of step S43 illustrated in FIG. 8.

[Step S43a] The I/O request processing unit 230 in the client 200a attaches available-space information indicating the available space obtained in step S42 to a write request and transmits the write request to the server 100a.

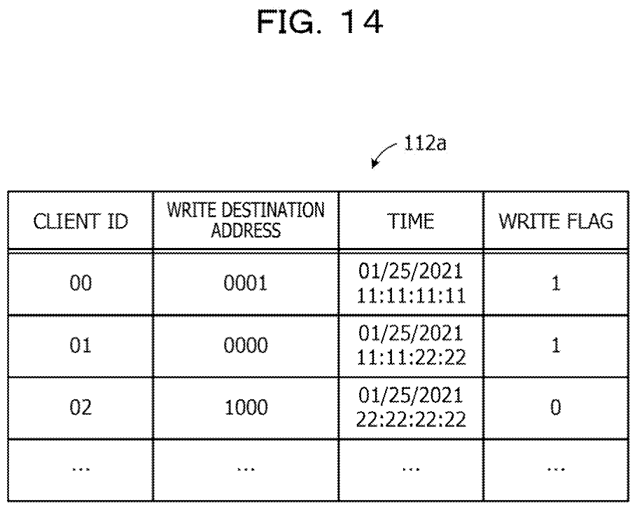

FIG. 14 illustrates a data configuration example of a write management table according to the third embodiment. In the third embodiment, a write management table 112a illustrated in FIG. 14 is stored in the management data storage unit 110 in the server 100a, instead of the write management table 112 illustrated in FIG. 5.

As illustrated in FIG. 14, in addition to the client ID, write destination address and time illustrated in FIG. 5, a write flag is registered with each record in the write management table 112a. The write flag is used for measuring the number of times of writing to different write destination addresses and the amount of written data in a predetermined period of time (which is a period for measuring the number of times of writing and the amount of written data). When writing to one write destination address is requested within the measurement period, the write flag is set to “1”, and addition to the number of times of writing and the amount of written data is performed. When writing to the same write destination address is then requested within the same measurement period, the addition to the number of times of writing and the amount of written data is not performed because the write flag has“1”. Thus, the number of times of writing and the amount of written data may be accurately measured.

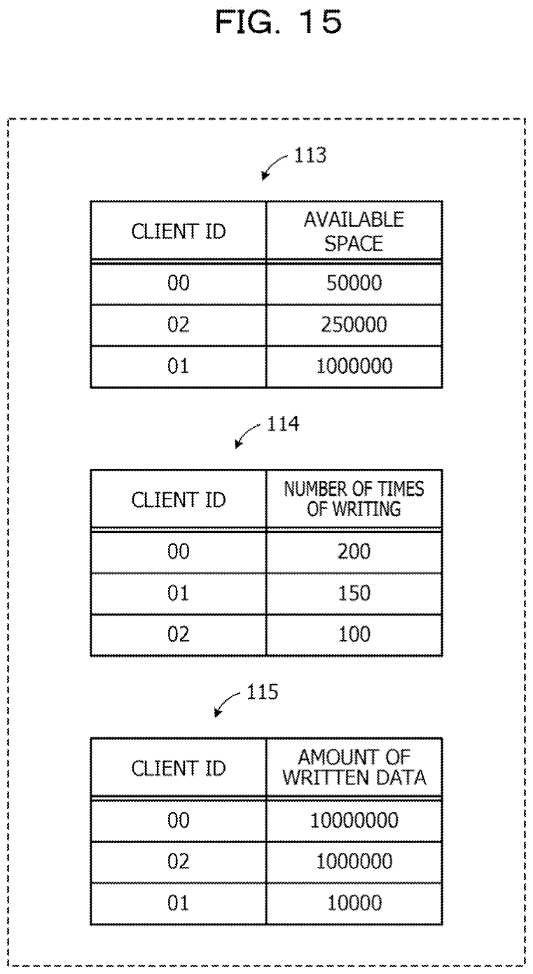

FIG. 15 illustrates other management data to be used in the third embodiment. In the third embodiment, an available space table 113, a number-of-times-of-writing table 114 and an amount-of-written-data table 115 illustrated in FIG. 15 are further stored in the management data storage unit 110 in the server 100a.

Records for each client are included in the available space table 113, and a client ID and an available space are registered with each of the records. The available space indicates an available space in the PMEM in the corresponding client.

Records for each client are included in the number-of-times-of-writing table 114, and a client ID and a number of times of writing are registered with each of the records. The number of times of writing indicates the number of requests to write to different write destination addresses from the corresponding client in the latest predetermined period of time (measurement period).

Records for each client are included in the amount-of-written-data table 115, and a client ID and an amount of written data are registered with each of the records. The amount of written data indicates the total amount of data requested to write to different write destination addresses from the corresponding client in the latest predetermined period of time (measurement period).

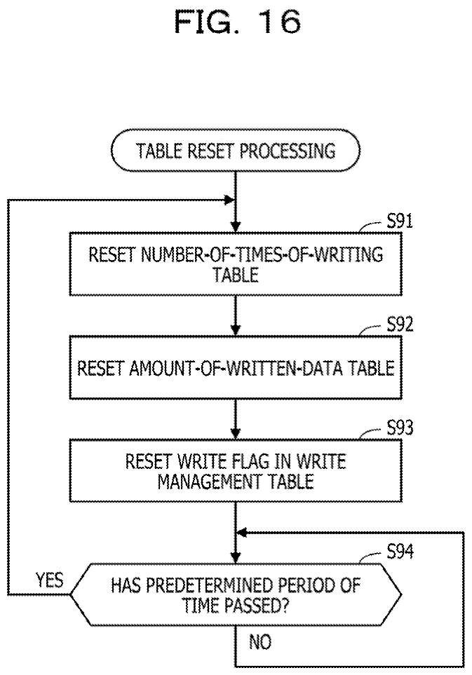

FIG. 16 is an example of a flowchart illustrating a procedure of table reset processing by the server.

[Step S91] The I/O control unit 120 in the server 100a resets the number of times of writing for each client registered with the number-of-times-of-writing table 114 to “0”.

[Step S92] The I/O control unit 120 resets the amount of written data for each client registered with the amount-of-written-data table 115 to “0”.

[Step S93] The I/O control unit 120 resets the write flag in all of the tables included in the write management table 112a to “0”.

[Step S94] The I/O control unit 120 keeps a wait state until a predetermined period of time passes. After the predetermined period of time passes, the processing in and after step S91 is executed again. Thus, the processing in steps S91 to S93 is repeatedly executed at predetermined time intervals. The interval for the execution of steps S91 to S93 is equal to a length of the measurement period for the number of times of writing and the amount of written data.

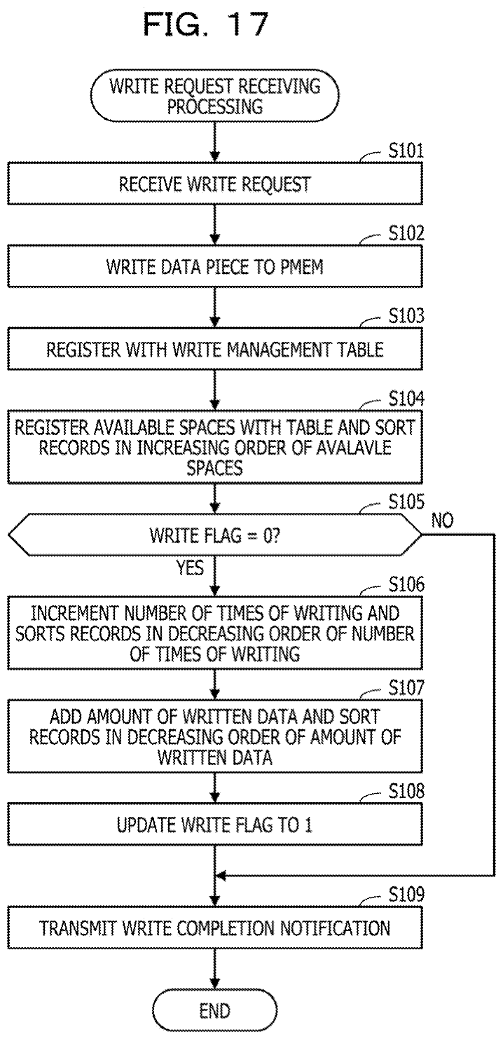

FIG. 17 is an example of a flowchart illustrating a procedure of write request receiving processing by the server according to the third embodiment. In the third embodiment, when the server 100a receives a request to write a data piece from a client, processing illustrated in FIG. 17 is executed, instead of the processing illustrated in FIG. 11.

[Step S101] The I/O control unit 120 in the server 100a receives a request to write a data piece from a client.

[Step S102] The I/O control unit 120 writes the data piece requested to write to the PMEM 103.

[Step S103] The I/O control unit 120 generates a new record in the write management table 112a and registers a client ID indicating the transmission source client of the write request, a write destination address of the data piece requested to write, and the current time with the record. The write flag is set to “0”.

However, when any record exists to which the same address is registered as the write destination address of the data piece requested to write, the I/O control unit 120 updates the time registered with the record with the current time, without generating a new record.

[Step S104] The I/O control unit 120 identifies a record corresponding to the transmission source client of the write request from the available space table 113. The I/O control unit 120 overwrites for registering the available space in the PMEM in the transmission source client, which is attached to the write request, in the identified record. The I/O control unit 120 sorts the records in the available space table 113 in increasing order of available space.

[Step S105] The I/O control unit 120 determines whether the write flag registered with the corresponding record in the write management table 112a is “0”. The “corresponding record” herein refers to one of the record registered newly in step S103 and the registered record including the same address as the write destination address of the data piece requested to write. When the write flag is “0”, the processing proceeds to step S106, and, when the write flag is “1”, the processing proceeds to step S109.

[Step S106] The I/O control unit 120 identifies the record corresponding to the transmission source client of the write request from the number-of-times-of-writing table 114 and increments the number of times of writing registered with the identified record. The I/O control unit 120 sorts the records in the number-of-times-of-writing table 114 in decreasing order of number of times of writing.

[Step S107] The I/O control unit 120 identifies the record corresponding to the transmission source client of the write request from the amount-of-written-data table 115 and adds the size of the data piece requested to write to the amount of written data registered with the identified record. The I/O control unit 120 sorts the records in the amount-of-written-data table 115 in decreasing order of amount of written data.

[Step S108] The I/O control unit 120 updates the write flag registered with the corresponding record (see the description of step S105) in the write management table 112a with “1”.

[Step S109] The I/O control unit 120 transmits a write completion notification corresponding to the write request to the transmission source client of the write request.

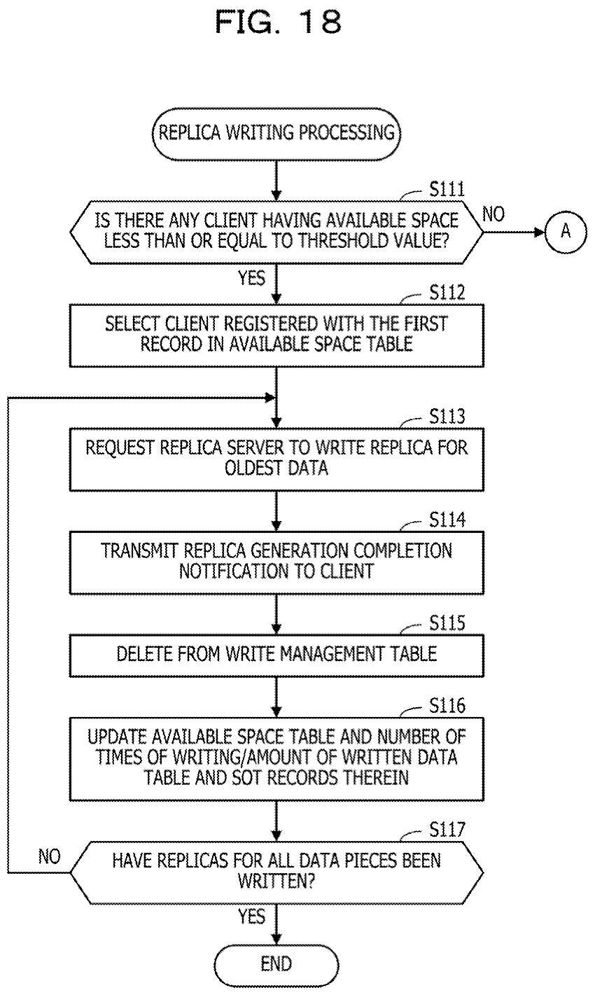

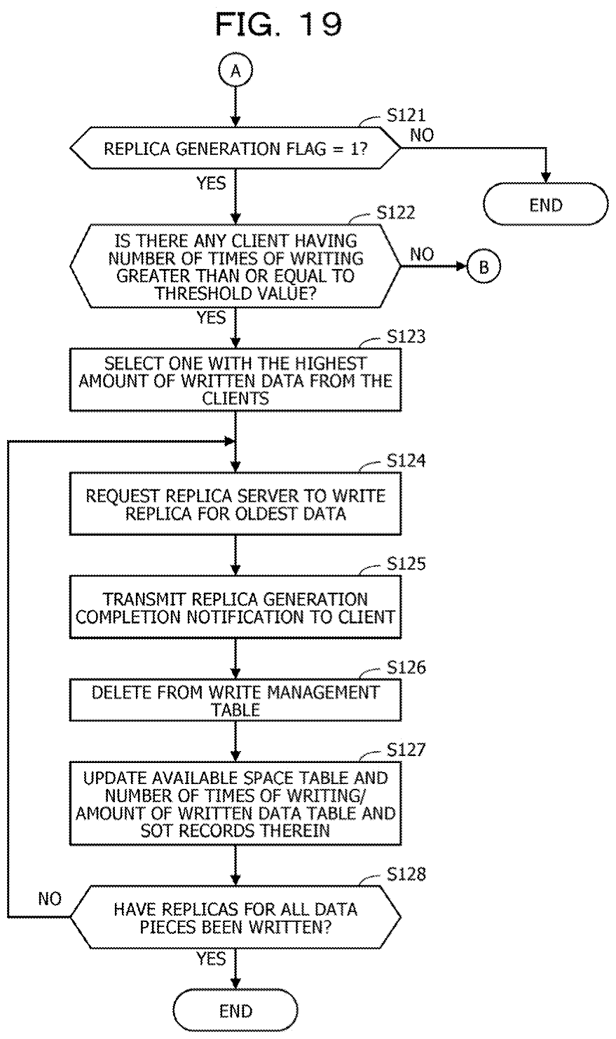

FIGS. 18 to 20 are examples of a flowchart illustrating a procedure of replica writing processing by the server according to the third embodiment. According to the third embodiment, the server 100a executes the processing in FIGS. 18 to 20, instead of the processing illustrated in FIG. 12. The processing illustrated in FIGS. 18 to 20 is repeatedly executed at predetermined time intervals.

[Step S111] The I/O control unit 120 in the server 100a determines whether there is any client having an available space in the PMEM less than or equal to a predetermined threshold value with reference to the available space table 113. When there is/are one or more corresponding clients, the processing proceeds to step S112, and when there is no corresponding client, the processing proceeds to step S121 in FIG. 19.

[Step S112] The I/O control unit 120 selects the client registered with the first record in the available space table 113 (a client having the smallest available space in the PMEM).

[Step S113] With reference to the write management table 112, the I/O control unit 120 selects the data piece having the oldest registered time (last written time) from among data pieces requested to write by the client selected in step S112. The I/O control unit 120 transmits to the server 100b (replica server) a replica write request that requests to write a replica of the selected data piece.

[Step S114] In response to receipt of a write completion notification for the replica write request, the I/O control unit 120 transmits to the transmission source client (which is the client selected in step S112) of the write request a replica generation completion notification indicating that the replica writing has completed. A write destination address for the corresponding data piece is attached to the replica generation completion notification.

[Step S115] The I/O control unit 120 deletes the record corresponding to the data piece selected in step S113 from the write management table 112.

[Step S116] The I/O control unit 120 subtracts the size of the data piece selected in step S113 from the available space registered with the record corresponding to the client selected in step S112 among the records in the available space table 113. The I/O control unit 120 sorts the records in the available space table 113 in increasing order of available space.

The I/O control unit 120 decrements the number of times of writing registered with the record corresponding to the client selected in step S112 among the records in the number-of-times-of-writing table 114. The I/O control unit 120 sorts the records in the number-of-times-of-writing table 114 in decreasing order of number of times of writing.

The I/O control unit 120 subtracts the size of the data piece selected in step S113 from the amount of written data registered with the record corresponding to the client selected in step S112 among the records in the amount-of-written-data table 115. The I/O control unit 120 sorts the records in the amount-of-written-data table 115 in decreasing order of amount of written data.

[Step S117] The I/O control unit 120 determines whether replicas have been written for all of the data pieces requested to write by the client selected in step S112 (data pieces with their corresponding records registered with the write management table 112). When any data piece exists for which replica writing has not been performed, the processing proceeds to step S113, and the data piece having the oldest last written time is selected from the corresponding data pieces. On the other hand, when replica writing has been executed for all of the corresponding data pieces, the replica writing processing ends.

Through the processing in FIG. 18 described above, for a data piece requested to write by a client having an available space in the PMEM that is less than or equal to the threshold value and is the smallest, the replica writing is executed, regardless of the access load on the DRAM in the replica server. This may suppress the possibility that the client may not request data writing because the available space of the PMEM in the client is exhausted.

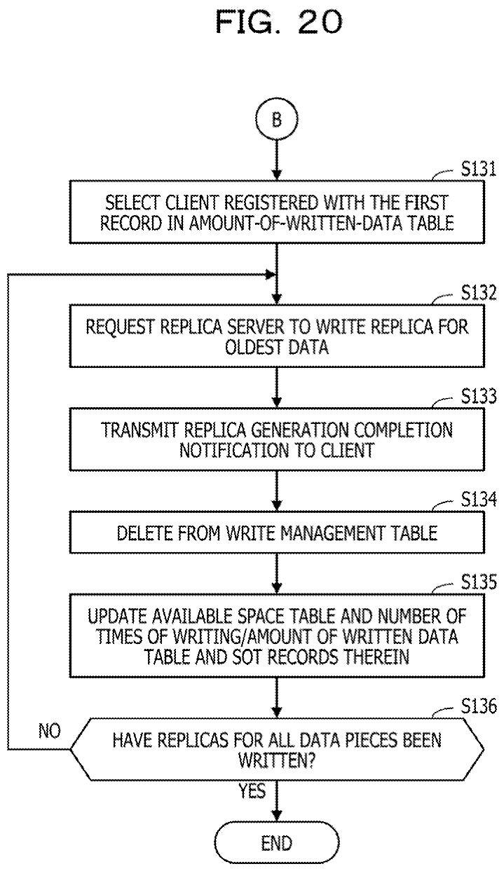

The description is continued below with reference to FIG. 19.

[Step S121] The I/O control unit 120 determines whether the replica generation flag 111 is “1”. When the replica generation flag 111 is “1”, the processing proceeds to step S122. Thus, the processing in and after the step S122 is executed when the access load on the DRAM in the replica server is low. On the other hand, when the replica generation flag 111 is “0”, the replica writing processing ends.

[Step S122] With reference to the number-of-times-of-writing table 114, the I/O control unit 120 determines whether there is any client having the number of times of writing greater than or equal to a predetermined threshold value. When there is/are one or more corresponding clients, the processing proceeds to step S123, and when there is no corresponding client, the processing proceeds to step S131 in FIG. 20.

[Step S123] With reference to the amount-of-written-data table 115, the I/O control unit 120 selects the client having the largest amount of written data from clients meeting the condition in step S122.

[Step S124] With reference to the write management table 112, the I/O control unit 120 selects the data piece having the oldest registered time (last written time) from among data pieces requested to write by the client selected in step S123. The I/O control unit 120 transmits to the server 100b (replica server) a replica write request that requests to write a replica of the selected data piece.

[Step S125] In response to receipt of a write completion notification for the replica write request, the I/O control unit 120 transmits to the transmission source client (which is the client selected in step S123) of the write request a replica generation completion notification indicating that the replica writing has completed. A write destination address for the corresponding data piece is attached to the replica generation completion notification.

[Step S126] The I/O control unit 120 deletes the record corresponding to the data piece selected in step S124 from the write management table 112.

[Step S127] The I/O control unit 120 subtracts the size of the data piece selected in step S124 from the available space registered with the record corresponding to the client selected in step S123 among the records in the available space table 113. The I/O control unit 120 sorts the records in the available space table 113 in increasing order of available space.

The I/O control unit 120 decrements the number of times of writing registered with the record corresponding to the client selected in step S123 among the records in the number-of-times-of-writing table 114. The I/O control unit 120 sorts the records in the number-of-times-of-writing table 114 in decreasing order of number of times of writing.

The I/O control unit 120 subtracts the size of the data piece selected in step S124 from the amount of written data registered with the record corresponding to the client selected in step S123 among the records in the amount-of-written-data table 115. The I/O control unit 120 sorts the records in the amount-of-written-data table 115 in decreasing order of amount of written data.

[Step S128] The I/O control unit 120 determines whether replicas have been written for all of data pieces requested to write by the client selected in step S123 (data pieces with their corresponding records registered with the write management table 112). When there is a data piece for which replica writing has not been performed, the processing proceeds to step S124, and the data piece having the oldest last written time is selected from the corresponding data pieces. On the other hand, when replica writing has been executed for all of the corresponding data pieces, the replica writing processing ends.

Through the processing in FIG. 19 described above, a client having a higher amount of written data in a predetermined period of time is selected by priority from clients having the numbers of times of writing greater than or equal to a threshold value in a predetermined period of time. A replica for a data piece requested to write by the selected client is written to the replica server.

The description is continued below with reference to FIG. 20.

[Step S131] The I/O control unit 120 selects a client registered at the first record of the amount-of-written-data table 115.

[Step S132] With reference to the write management table 112, the I/O control unit 120 selects the data piece having the oldest registered time (last written time) from among data pieces requested to write by the client selected in step S131. The I/O control unit 120 transmits to the server 100b (replica server) a replica write request that requests to write a replica of the selected data piece.

[Step S133] In response to receipt of a write completion notification for the replica write request, the I/O control unit 120 transmits to the transmission source client (which is the client selected in step S131) of the write request a replica generation completion notification indicating that the replica writing has completed. A write destination address for the corresponding data piece is attached to the replica generation completion notification.

[Step S134] The I/O control unit 120 deletes the record corresponding to the data piece selected in step S132 from the write management table 112.

[Step S135] The I/O control unit 120 subtracts the size of the data piece selected in step S132 from the available space registered with the record corresponding to the client selected in step S131 among the records in the available space table 113. The I/O control unit 120 sorts the records in the available space table 113 in increasing order of available space.

The I/O control unit 120 decrements the number of times of writing registered with the record corresponding to the client selected in step S131 among the records in the number-of-times-of-writing table 114. The I/O control unit 120 sorts the records in the number-of-times-of-writing table 114 in decreasing order of number of times of writing.

The I/O control unit 120 subtracts the size of the data piece selected in step S132 from the amount of written data registered with the record corresponding to the client selected in step S131 among the records in the amount-of-written-data table 115. The I/O control unit 120 sorts the records in the amount-of-written-data table 115 in decreasing order of amount of written data.

[Step S136] The I/O control unit 120 determines whether replica writing has been performed for all of data pieces requested to write by the client selected in step S131 (data pieces with their corresponding records registered with the write management table 112). When there is a data piece for which replica writing has not been performed, the processing proceeds to step S132, and the data piece having the oldest last written time is selected from the corresponding data pieces. On the other hand, when replica writing has been executed for all of the corresponding data pieces, the replica writing processing ends.

Through the processing in FIG. 20 described above, a client having the larger amount of written data in a predetermined period of time is selected by priority, and a replica for a data piece requested to write from the selected client is written to the replica server.

### Fourth Embodiment

A storage system according to a fourth embodiment is acquired by changing a part of the processing of the storage system according to the third embodiment. According to the fourth embodiment, when the available space of the PMEM in a client requesting to write a data piece is exhausted, the replica of the data piece is temporarily written to the PMEM of any other client. This may allow the client to request to write a data piece even when the available space of the PMEM of the client is exhausted.

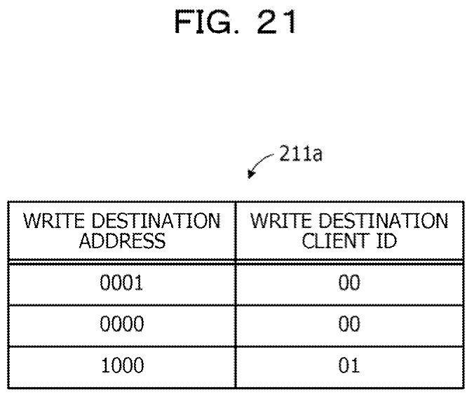

FIG. 21 illustrates a data configuration example of a replica management table held by a client according to the fourth embodiment. A replica management table 211a illustrated in FIG. 21 is stored in the management data storage unit 210 in the client 200a, instead of the replica management table 211 illustrated in FIG. 4. A write destination address of a data piece requested to write and a write destination client ID identifying a client to which a replica of the data piece is written are registered in association with the replica management table 211a. A client ID indicating the client (client 200a) or any other client is registered with the field for the write destination client ID.

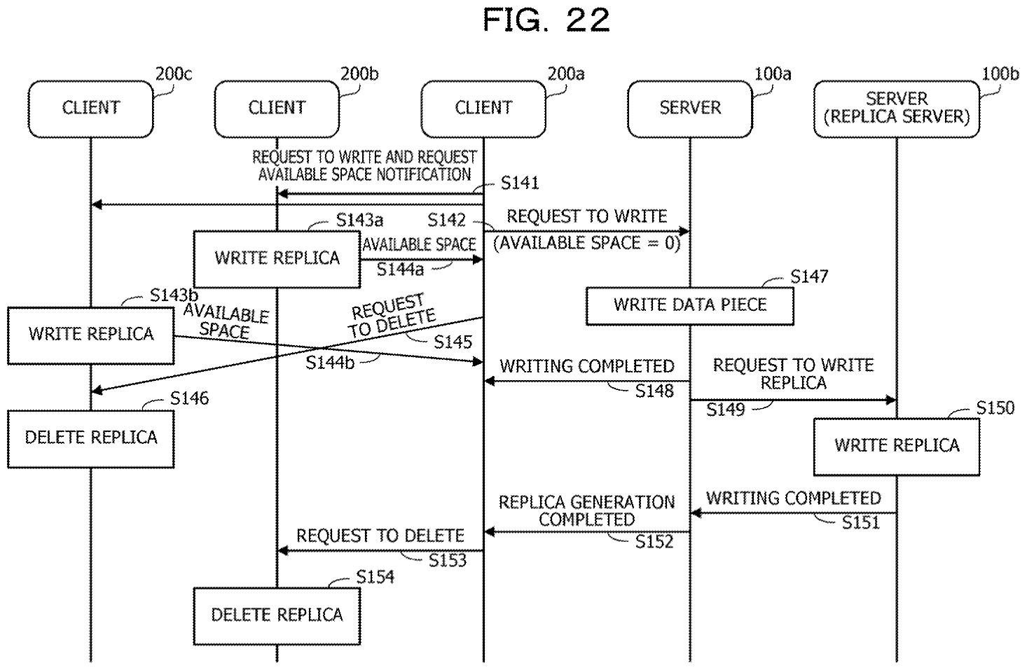

FIG. 22 is a sequence diagram illustrating an example of data writing processing in the storage system according to the fourth embodiment. Referring to FIG. 22, clients 200a to 200c exist, and it is assumed that the client 200a requests to write a data piece to the server 100a.

First of all, before requesting to write a data piece, the client 200a determines whether the available space in the PMEM 201 in the client 200a is larger than or equal to the size of the data piece requested to write. When the available space is smaller than the size of the data piece, the client 200a transmits to the clients 200b, 200c a command to request to write a replica of the data and to request notification of the available space (step S141). With that, the client 200a transmits a request to write the data piece to the server 100a (step S142). At that time, available-space information indicating that the available space in the PMEM 201 is “0” is attached to the write request.

In response to the request to write a replica and the request for notification of the available space, the client 200b writes the replica to the PMEM in the client 200b (step S143a) and notifies the client 200a of the available space in the PMEM (step S144a). In response to the request to write a replica and the request for notification of the available space, the client 200c also writes the replica to the PMEM in the client 200c (step S143b) and notifies the client 200a of the available space in the PMEM (step S144b).

It is assumed that the available space from the client 200b is notified to the client 200a earlier than the available space from the client 200c and that the available space notified from the client 200b is larger than or equal to the size of the data requested to write. In this case, the client 200a registers the client ID of the client 200b as the write destination client ID for the replica with the replica management table 211a in association with the write destination address. The client 200a transmits a request to delete the replica to all clients (the client 200c here) other than the client 200b (step S145). In response to receipt of the delete request, the client 200c deletes the replica written to the PMEM (step S146).

On the other hand, the server 100a having received the request to write the data piece writes the data piece requested to write to the PMEM 103 in the server 100a (step S147) and transmits a write completion notification to the client 200a (step S148). When the available-space information attached to the write request indicates the available space=0, the server 100a transmits to the server 100b (replica server) a replica write request to request to write a replica of the data piece immediately after transmitting the write completion notification (step S149).

In response to receipt of the replica write request, the server 100b writes the replica to the PMEM 102b in the server 100b (step S150) and transmits to the server 100a a replica write completion notification indicating that the writing has completed (step S151). In response to receipt of the replica write completion notification, the server 100a transmits to the client 200a a replica generation completion notification (step S152).

In response to receipt of the replica generation completion notification, the client 200a determines that the write destination for the replica is the client 200b from the replica management table 211a and transmits a request to delete the replica to the client 200b (step S153). In response to receipt of the delete request, the client 200b deletes the replica written to the PMEM (step S154).

Through the processing described above, when the available space in the PMEM 201 in the client 200a is exhausted, a replica of a data piece requested to write is written to the PMEM in another client which has the available space in the PMEM larger than or equal to the size of the data piece and which has notified the available space earlier. Thus, even when the available space in the PMEM 201 is exhausted, the client 200a may request to write a data piece by achieving redundancy of the data piece and keeping its security.

Next, processing by the client 200a and the server 100a is described by using flowcharts.

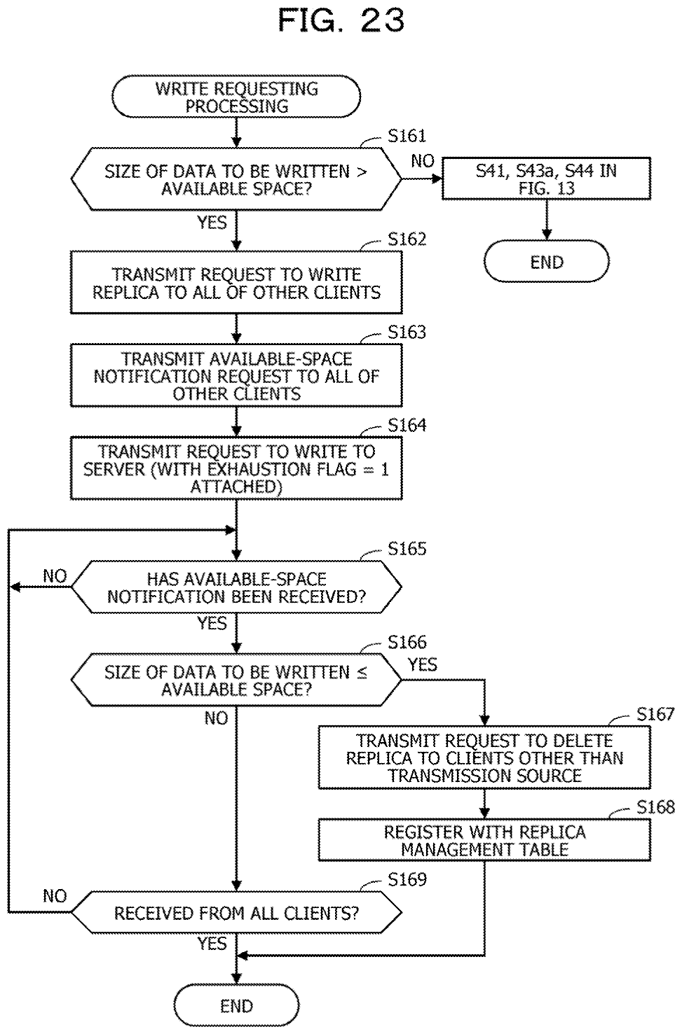

FIG. 23 is an example of a flowchart illustrating a procedure of write requesting processing by a client according to the fourth embodiment.

[Step S161] The I/O request processing unit 230 in the client 200a obtains the available space in the PMEM 201 from the available space monitoring unit 220 and determines whether the size of data requested to write is larger than the available space. When the size of the data is smaller than or equal to the available space, the processing in steps S41, S43, and S44 in FIG. 13 is sequentially executed. On the other hand, when the size of the data is larger than the available space, the processing proceeds to step S162.

[Step S162] The I/O request processing unit 230 transmits to all of the other clients a replica write request that requests to write a replica of the data piece.

[Step S163] The I/O request processing unit 230 transmits to all of the other clients an available-space notification request to request notification of the available space in the PMEM.

[Step S164] The I/O request processing unit 230 attaches available-space information indicating the available space is “0” to the write request and transmits the write request to the server 100a.

[Step S165] The I/O request processing unit 230 monitors the available-space notification corresponding to the available-space notification request transmitted in step S163. When the available-space notification is received from any other client, the processing proceeds to step S166.

[Step S166] The I/O request processing unit 230 determines whether the size of the data piece requested to write is smaller than or equal to the notified available space. When the size of the data piece is smaller than or equal to the available space, the processing proceeds to step S167, and, when the size of the data piece is larger than the available space, the processing proceeds to step S169.

[Step S167] The I/O request processing unit 230 transmits a replica delete request to all of the clients other than the transmission source of the available-space notification received in step S165.

[Step S168] The I/O request processing unit 230 generates a new record in the replica management table 211a, registers a write destination address of the data piece with the record, and registers, as a write destination client ID, a client ID of the transmission source client of the available-space notification received in step S165.

[Step S169] The I/O request processing unit 230 determines whether the available-space notification has been received from all of the other clients having transmitted the available-space notification request. When there is any client from which the available-space notification has not been received, the processing proceeds to step S165 where receipt of the available-space notification is waited. On the other hand, when the available-space notification has been received from all of the other clients, redundancy of the data piece at the current point in time is not possible. In this case, a new record is generated in the replica management table 211a, and a write destination address for the data piece is registered with the record while the write destination client ID is not registered.

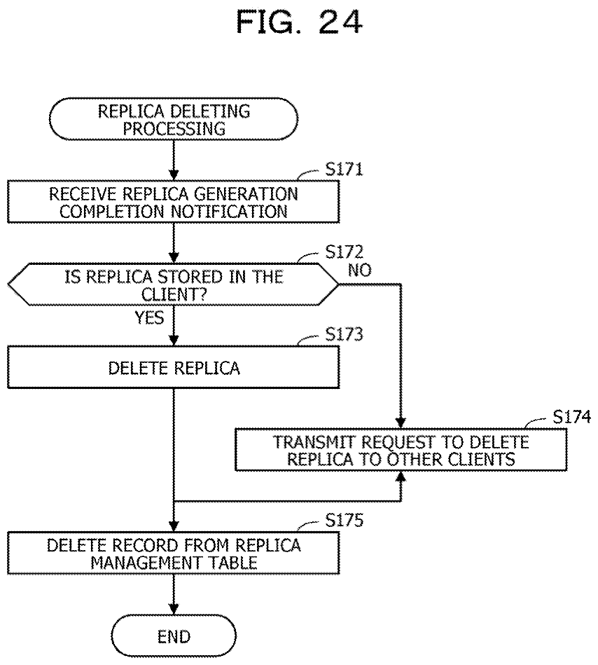

FIG. 24 is an example of a flowchart illustrating a procedure of replica deleting processing by a client according to the fourth embodiment.

[Step S171] The I/O request processing unit 230 in the client 200a receives a replica generation completion notification from the server 100a. A write destination address for the corresponding data piece to be written is attached to the replica generation completion notification.

[Step S172] The I/O request processing unit 230 extracts the write destination address attached to the replica generation completion notification from the replica management table 211a and extracts the write destination client ID associated with the write destination address. The I/O request processing unit 230 determines whether the replica is being stored in the client 200a based on the extracted write destination client ID. When the replica is being stored in the client 200a, the processing proceeds to step S173, and when the replica is not being stored in another client, the processing proceeds to step S174.

[Step S173] The I/O request processing unit 230 deletes the replica corresponding to the write destination address from the PMEM 201 in the client 200a.

[Step S174] The I/O request processing unit 230 transmits to the other clients indicated by the write destination client ID a replica delete request by designating the write destination address. Thus, the replica is deleted from the PMEM in the client.

[Step S175] The I/O request processing unit 230 deletes the record from which the write destination address and the write destination client ID are extracted in step S172 from the replica management table 211a.

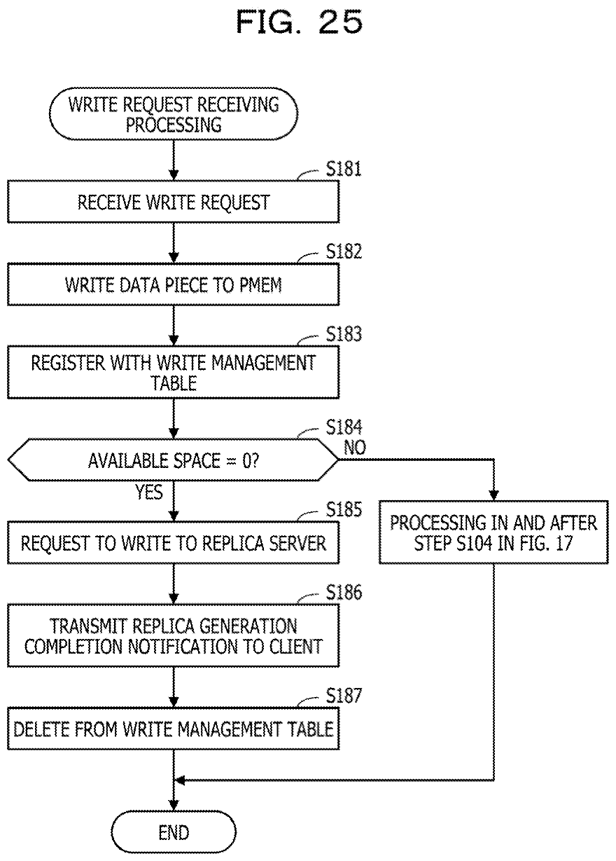

FIG. 25 is an example of a flowchart illustrating a procedure of write request receiving processing by the server according to the fourth embodiment.

[Step S181] The I/O control unit 120 in the server 100a receives a request to write a data piece from a client.

[Step S182] The I/O control unit 120 writes the data piece requested to write to the PMEM 103.

[Step S183] The I/O control unit 120 generates a new record in the write management table 112a and registers a client ID indicating the transmission source client of the write request, a write destination address of the data piece requested to write and the current time with the record. The write flag is set to “0”.

However, when any record exists to which the same address is registered as the write destination address of the data piece requested to write, the I/O control unit 120 updates the time registered with the record with the current time, without generating a new record.

[Step S184] The I/O control unit 120 determines whether the available-space information attached to the received write request indicates available space=0. When available space=0 is indicated, the processing is then advanced to step S181. On the other hand, when the available space indicates a value greater than 0, processing in and after step S104 in FIG. 17 is executed.

[Step S185] The I/O control unit 120 transmits to the server 100b (replica server) a replica write request that requests to write a replica of the data piece requested to write.

[Step S186] In response to receipt of a write completion notification for the replica write request, the I/O control unit 120 transmits, to the transmission source client of the write request, a replica generation completion notification indicating that the replica writing has completed. A write destination address for the corresponding data piece is attached to the replica generation completion notification.

[Step S187] The I/O control unit 120 deletes the record with which the write destination address for the data is registered from the write management table 112.

The processing functions of the apparatuses (for example, the information processing apparatus 10, the storage control apparatuses 20, 30, the servers 100a, 100b, and the clients 200a, 200b, 200c, . . . ) illustrated in each of the above embodiments may be implemented by a computer. In such a case, a program describing the details of the processing of the functions to be included in each apparatus is provided, and with a computer executing the program, the above-described processing functions are implemented over the computer. The program describing the details of the processing may be recorded in a computer-readable recording medium. The computer-readable recording medium may be a magnetic storage device, an optical disc, a semiconductor memory, or the like. The magnetic storage device may be a hard disk drive (HDD), a magnetic tape, or the like. The optical disc may be a compact disc (CD), a Digital Versatile Disc (DVD), a Blu-ray disc (BD, registered trademark), or the like.

When the program is distributed, for example, a portable recording medium such as a DVD or a CD in which the program is recorded is sold. The program may also be stored in a storage device of a server computer and be transferred from the server computer to another computer via a network.

The computer that executes the program stores, in a storage device thereof, the program recorded in the portable recording medium or the program transferred from the server computer, for example. The computer reads the program from the storage device thereof and performs processing according to the program. The computer may also read the program directly from the portable recording medium and perform processing according to the program. Each time the program is transferred from the server computer coupled to the computer via the network, the computer may also sequentially perform processing according to the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage system comprising: an information processing apparatus, a first storage control apparatus, and a second storage control apparatus, wherein
the information processing apparatus includes:
a first storage device; and
a first processing circuit configured to
transmit a data write request for a data piece to be written to the first storage control apparatus,
write a first replica corresponding to the data piece to be written to the first storage device, and
in response to receipt of a replica write completion notification corresponding to the data write request, delete the first replica from the first storage device,
the first storage control apparatus includes:
a second storage device; and
a second processing circuit configured to
monitor a processing load on the second storage control apparatus,
in response to receipt of the data write request from the information processing apparatus, write the data piece to be written to the second storage unit and transmit a write completion notification to the information processing apparatus,
in response that an indicator indicating the processing load is less than or equal to a predetermined threshold value after the transmission of the write completion notification, transmit to the second storage control apparatus a replica write request that requests to write a second replica corresponding to the data piece to be written, and
in response that the writing of the second replica completes, transmit the replica write completion notification corresponding to the data write request to the information processing apparatus, and
the second storage control apparatus has
a third storage device; and
a third processing circuit configured to
in response to receipt of the replica write request, write the second replica to the third storage device.

2. The storage system according to claim 1, wherein
in response that the first storage device has an available space less than or equal to a predetermined first space threshold value, the first processing circuit attaches available-space information indicating that the available space is small to the data write request and transmits the data write request to the first storage control apparatus, and
in response that the received data write request has the available-space information attached, the second processing circuit writes the data piece to be written to the second storage device and transmits the replica write request to the second storage control apparatus, and, when the writing of the data piece to be written and the second replica completes, the replica write completion notification is transmitted to the information processing apparatus as a response to the data write request.

3. The storage system according to claim 1, wherein
the storage system comprises a plurality of the information processing apparatuses each having the first storage device and the first processing circuit,
the first processing circuit of each of the information processing apparatuses notifies an available space in the first storage device to the first storage control apparatus in requesting the first storage control apparatus to write a data piece, and
the second processing circuit
writes a data piece requested to write to the second storage device every time the second processing circuit receives a data write request from each of the information processing apparatuses,
notifies that the writing has completed to the information processing apparatus having requested the writing, and
registers the available space notified from the information processing apparatus having requested the writing with available space management information, and
even when an indicator indicating the processing load has any value, selects the information processing apparatus in increasing order of the registered available space from among the information processing apparatuses with the available space, which is registered with the available space management information, less than or equal to a predetermined second space threshold value and requests the second storage control apparatus to write a replica of the data piece written to the second storage unit in response to a request from the selected information processing apparatus.

4. The storage system according to claim 3, wherein
the second processing circuit
registers the number of data write requests for different write destinations in a predetermined period of time with number-of-requests management information for each of the information processing apparatuses,
registers a data amount of a data piece requested to write at the different write destinations in the predetermined period of time with a mount-of-data management information for each of the information processing apparatuses, and
when the indicator indicating the processing load has a value less than or equal to the predetermined threshold value, selects the information processing apparatus in decreasing order of the amount of data registered with the amount-of-data management information from among the information processing apparatuses with the number of requests, which is registered with the number-of-requests management information, greater than or equal to a predetermined threshold value and requests the second storage control apparatus to write a replica of the data written to the second storage device in response to a request from the selected information processing apparatus.

5. The storage system according to claim 1, further comprising another information processing apparatus, wherein
the first processing circuit is configured to:
in response that the first storage device has an available space smaller than a size of the data piece to be written, transmit the data write request to the first storage control apparatus, and request the other information processing apparatus to write the first replica; and
in response to receipt of the replica write completion notification from the first storage control apparatus, request the other information processing apparatus to delete the first replica.

6. The storage system according to claim 1, further comprising a plurality of other information processing apparatuses each having a fourth storage device, wherein
the first processing circuit is configured to:
in response that the first storage device has an available space smaller than a size of the data piece to be written, transmit the data write request to the first storage control apparatus and requests the plurality of other information processing apparatuses to write the first replica to the fourth storage units and to notify the available space of the fourth storage devices;
request to delete the first replica to all of the other information processing apparatuses excluding one information processing apparatus having an available space in the fourth storage device greater than or equal to a size of the data piece to be written and having notified the available space of the fourth storage unit first among the plurality of other information processing apparatuses; and
in response to receipt of the replica write completion notification from the first storage control apparatus, request the one information processing apparatus to delete the first replica.

7. A computer-implemented storage control method in a storage system including an information processing apparatus having a first storage device, a first storage control apparatus having a second storage device, and a second storage control apparatus having a third storage device, the method comprising:
by the information processing apparatus, transmitting a data write request for a data piece to be written to the first storage control apparatus and writing a first replica corresponding to the data piece to be written to the first storage device;
by the first storage control apparatus,
monitoring a processing load on the second storage control apparatus,
in response to receipt of the data write request from the information processing apparatus, writing the data piece to be written to the second storage device,
transmitting to the second storage control apparatus a write completion notification to the information processing apparatus,
in response that an indicator indicating the processing load is less than or equal to a predetermined threshold value after the transmission of the write completion notification, transmitting a replica write request that requests to write a second replica corresponding to the data piece to be written to the third storage device, and
in response that the writing of the second replica completes, transmitting the replica write completion notification corresponding to the data write request to the information processing apparatus; and
by the information processing apparatus, in response to receipt of the replica write completion notification, deleting the first replica from the first storage device.
